(19) United States
(12) Patent Application Publication
(10) Pub. No.: US 2006/0059912 A1
(43) Pub. Date: Mar. 23, 2006

(54) Vapor pump power system

(76) Inventors: Pat Romanelli, Harrington Park, NJ (US); Donald R. Bedwell, Columbia City, IN (US); Robert J. Romanelli, Savannah, GA (US)

Correspondence Address: WINSTON & STRAWN LLP, 1700 K STREET, N.W., WASHINGTON, DC, 20006, US

(21) Appl. No.: 10/942,984

(22) Filed: Sep. 17, 2004

(51) Int. Cl. F01K 13/00; F01K 25/02; F02G 1/00

(52) U.S. Cl. 60/645; 60/650

(57) ABSTRACT

A power plant with at least two pressure vessels containing a hydraulic fluid. A heat exchanging assembly is in heat transferring association with the pressure vessels. The hydraulic conduit is hydraulically connected with the pressure vessels. A power outlet device is in hydraulic association with the conduit between the vessels and is configured for outputing power from the flow of the hydraulic fluid. A controlling mechanism is operably associated with the heat exchanging assembly to cause the heat exchanging assembly to alternately increase the pressure in one of the pressure vessels compared to the other. Thus, hydraulic fluid is caused to flow through the power outlet device alternately between the pressure vessels to produce power from the power output device.

### FIELD OF THE INVENTION

The present invention related to the production of power. More particularly, the invention relates to producing power by varying the temperature in pressure vessels to drive a hydraulic fluid.

### BACKGROUND OF THE INVENTION

The present day forms of creating power are generally dependent upon the burning of fossil fuels to generate electric power. In doing so, a serious environmental problem is created in the form of air, water and land pollution. Also, in burning such fuels to create kinetic energy, thermal efficiencies are relatively low due to the formation of incomplete combustion products. This results in exhaust pollution of these products, such as carbon monoxide, carbon dioxide, nitrous oxides and particulates.

Certain attempts have been made to create power without generating such pollutants. U.S. Pat. Nos. 4,086,772 and 4,170,116 disclose a continuous method and closed cycle system for converting thermal energy into mechanical energy. This system comprises vaporizing means, including an energy conversion tube having a special nozzle section, for converting a liquid working fluid stream to a vapor stream. This vapor stream operates a turbine means wherein a portion of the energy of the vapor stream is converted to mechanical shaft work. This system also includes means for increasing the thermal and static energy content of the fluid stream, this means typically being pump means. The vapor fraction of that exits the turbine means passes through condensing means, such as a diffuser, to regenerate the working liquid stream. Finally, means are provided for recycling the condensed liquid stream back to the vaporizing means. The working fluid may be carbon dioxide, liquid nitrogen, or a fluorocarbon. Preferred fluorocarbons are difluoromonochloromethane, pentafluoromonochloroethane, difluorodichloromethane and mixtures and azeotropes thereof.

U.S. Pat. Nos. 4,805,410 and 4,698,973 disclose closed loop systems that recirculate a vaporizable working fluid between its liquid and vapor states in a thermodynamic working cycle. In this cycle, energy received from an external energy source is utilized to vaporize the fluid to a high pressure in a boiler unit. The resulting vapor is utilized in an energy utilizing device, such as a slidable piston which causes rotation of a crank shaft coupled to a flywheel to deliver mechanical output at a rotating shaft connected thereto. Thereafter, the vapor is condensed into a condensate at a relatively lower pressure in a condensing unit and then is returned to the boiler unit for repeating of the thermodynamic cycle. Also, the condensate flow between the condensing unit and boiler unit is collected in one of two holding tanks in selective pressure communication with the boiler unit. Preferred working fluids include water, Freon or ammonia. Also, thermal regeneration means may be included for providing regenerative heating of the working fluid.

U.S. Pat. No. 5,551,237 discloses a method for producing hydroelectric power in which sunlight is used to generate vapor in a liquid. The vapor is then fed into tanks to push water out from the tanks and through a Pelton wheel to generate power.

A power plant is needed that can more reliably and efficiently produce power that can preferably allow a generally continuous production.

### SUMMARY OF THE INVENTION

The present invention is related to a power plant that has at least two pressure vessels containing a hydraulic fluid. The heat exchanging assembly is in heat transferring association with the pressure vessels. A hydraulic conduit hydraulically connects the pressure vessels, and a power output device is in hydraulic association with the conduit between the vessels. The power output device is configured for outputting power from the flow of the hydraulic fluid through the conduit. A controlling mechanism is operably associated with the heat exchanging assembly to cause the heat exchanging assembly to alternately produce an increased pressure in a first of the pressure vessels compared to a second of the pressure vessels, and then increases in the second pressure vessel unopened to the first, such that the hydraulic fluid flows through the power output device alternatively between the pressure vessels so that the power output device produces power.

In a preferred embodiment, an expandable member is provided in thermal association with the heat exchanging assembly to expand and contract in response to alternating heat exchange with the heat exchanging assembly. The expandable member is preferably operably associated with the hydraulic fluid in the pressure vessels to bias the hydraulic fluid alternately between the pressure vessels through the conduit and is in hydraulic association with the hydraulic fluid. Expandable fluid can be substantially maintained within the power plant, such that the cycling thereof is closed and along a closed circuit. A preferred expandable fluid is a fluorocarbon, and is preferably a gas. Additionally, the expandable fluid can change between liquid and gaseous states during the repeating cycles of expansion and contraction. The preferred expandable member is configured to expand when heated and contract when cooled.

Hot and cold sources of a thermal conducting fluid can be provided in the heat exchanging assembly. Additionally, the controlling mechanism can include at least one temperature controlling valve to direct the thermal conducting fluid to the pressure vessels alternately from the hot source to heat the expandable fluid, and from the cold source to cool the expandable fluid. A preferred controlling mechanism includes a controller that is operably associated with the temperature controlling valve, and a vessel sensor sensing association with at least one of the pressure vessels. The vessel sensor is configured to sense the level of hydraulic fluid within the vessel, and the controllers connected to the vessel sensor and configured for operating the temperature controlling valve depending on the hydraulic fluid level that has been sensed. The vessel sensor is associated with only one of the pressure vessels in a preferred embodiment, but can alternatively be associated with other pressure vessels. The controller can comprise electric circuitry associated with the vessel sensor and for controlling the temperature controlling valve.

The conduit preferably comprises outflow and inflow portions that are hydraulically connected between the pressure vessels and the power output device. Flow directing valves are associated with the outflow and inflow portions to allow the hydraulic fluid to flow only from the pressure vessels to the power output device in the outflow portions, and from the power output device to the pressure vessels in the inflow portions. The flow directing valves can be one-way flow valves. In addition, an accumulator can be hydraulically connected to the conduit upstream of the power output device, such as between the outflow portions of the conduit, for smoothing changes in pressure flow rate of the hydraulic fluid flowing to and through the power output device. The accumulator can be provided between two one-way flow valves that are configured to allow flow only towards the accumulator from the pressure vessels.

In embodiments in which inflow and outflow portions of the conduit are provided, the hydraulic fluid can be configured to hydraulically flow in a closed figure-eight circuit, passing twice through the power output device before returning to a pressure vessel from which it started. Although in the preferred embodiment the outflow and inflow portions are directly connected to each pressure vessel, in an alternative embodiment, these portions can be connected to other portions of the conduit that lead directly to the pressure vessels. The conduit can be configured so that the hydraulic fluid in the closed circuit is directed sequentially from a first of the pressure vessels, through a first of the outflow portions, through the power output device, through a second of the inflow portions, to a second of the pressure vessels, through a second of the outflow portions, through the power output device, through a first of the inflow portions, and back to the first pressure vessel.

A preferred power output device comprises a transducer for converting the hydraulic power from the hydraulic fluid flow. A preferred transducer is a hydraulic motor or generator.

In a preferred method according to the invention, first and second pressure vessel are alternatively and sequentially heated and cooled. One vessel is heated while the other is cooled to alternately increase the pressure of one of the vessels with respect to the other. This displaces hydraulic fluid reciprocably between the vessels through a hydraulic conduit. The hydraulic fluid flows through the conduit and through a power output device to produce the output power.

Preferably, the pressure in the vessels is varied by alternately heating and cooling an expandable gas within the pressure vessels. Additionally, the gas is preferably substantially maintained within the power plant throughout the alternating increase and decrease of pressures. Additionally, it is preferred to operate flow directing valves to flow the hydraulic fluid in a single direction to the power output device regardless of whether the flow is from the first to the second pressure vessel or from the second to the first pressure vessel. The present invention this provides a simple power plant that can be worked with relatively small temperature differences.

### BRIEF DESCRIPTION OF THE DRAWINGS

FIG. 1 is a schematic view of a power plant constructed according to the present invention;

FIG. 2 is an enlarged cross-sectional view of a first pressure vessel thereof, including a diagrammatic view of circuitry to control heating and cooling of the pressure vessels;

FIG. 3 is a schematic view of another embodiment of a power plant with an open heating and cooling circuit;

FIG. 4 is a diagram showing a preferred embodiment of a power flow circuit according to the invention; and

FIG. 5 is a cross-sectional view of another embodiment of a pressure vessel.

### DETAILED DESCRIPTION OF THE PREFERRED EMBODIMENTS

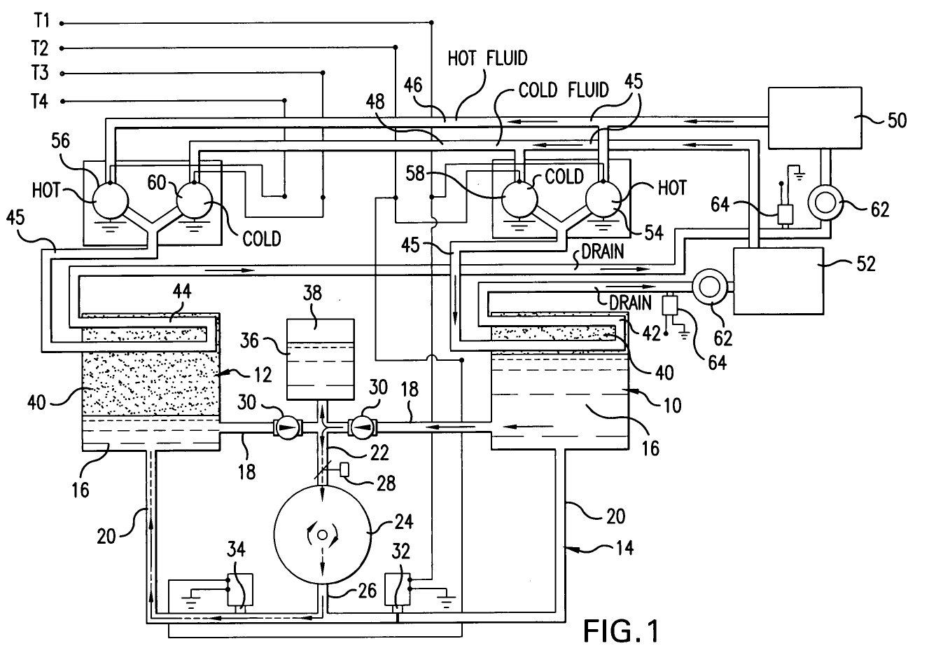

Referring to FIG. 1, the preferred embodiment constructed according to the invention includes first and second pressure vessels 10,12 that are hydraulically connected via a hydraulic conduit 14. In the preferred embodiment, two pressure vessels are employed, although additional vessels can be used in alternative embodiments. Additionally, each pressure vessel is preferably a single vessel, but alternatively, several vessels can be linked as to operate together as a single vessel.

Hydraulic fluid 16 is contained within the pressure vessels 10,12 and the conduit 14, which fluidly communicates the pressure vessels 10,12 and allows the hydraulic fluid to flow from one vessel to the other 12,10. The preferred conduit 14 includes vessel outflow portions 18 connected to each pressure vessel 10,12 to receive hydraulic fluid 16 flowing therefrom. The conduit 14 also preferably includes vessel inflow portions 20 configured to direct the hydraulic fluid 16 into each pressure vessel 10,12.

Between the vessel outflow portions 18, the conduit 14 includes a motor inflow portion 22 that directs the flowing hydraulic fluid 16 from the vessel outflow portions 18 and delivers it to a power output device, which in the preferred embodiment is a motor 24 that includes a generator or alternator. A hydraulic or pneumatic motor can be used. The power output device can alternatively comprise another type of transducer for converting hydraulic power from the hydraulic fluid flow into another form of power, such as electrical power. The motor 24, which is thus in hydraulic association with the conduit 14 between the pressure vessels 10,12, is configured for producing power from the hydraulic flow of the hydraulic fluid 16 that flows through the conduit 14. The conduit 14 includes a motor outflow portion 26 hydraulically connected to an outlet of the motor 24 that directs the flowing hydraulic fluid 16 to the vessel inflow portions 20.

A user-controllable valve 28 can be provided, such as in the motor inflow portion 22, as shown, or motor outflow portion 26 to selectively stop the hydraulic fluid flow through the motor 24. Flow directing valves 30,32,34 are preferably associated with the vessel outflow and inflow portions 18,20 to direct the hydraulic fluid 16 through the conduit 14. The flow directing valves 30,32,34 preferably cause the hydraulic fluid 16 to flow in a single direction through the motor 24 and motor inflow and outflow portions 22,26. The flow directing valves 30,32,34 also preferably direct the hydraulic fluid 16 only out from the pressure vessels 10,12 and into the motor inflow portion 22 through the vessel outflow portions 18, and to the pressure vessels 10,12 from the motor outflow portion 26 through the vessel inflow portions 20.

This arrangement allows the use of a motor 24 or other power output device that requires hydraulic flow therethrough in a single direction. Other arrangements of flow directing valves 30,32,34 and conduit 14 can be used for alternative types of power output devices, such as devices that can employ flow in alternative directions to produce power. The conduit 14 and the flow directing valves 30,32,34 are preferably configured flowing the hydraulic fluid 16 hydraulically in a closed figure-eight circuit. In the preferred embodiment shown, this closed circuit passes the hydraulic fluid 16 twice through the motor 24 before returning to the same one of the pressure vessels 10,12.

Flow directing valves 30, which are associated with the vessel outflow portions 18, are preferably one-way valves, such as check valves or other suitable valves to allow flow in one direction and block the flow in opposite direction. Other valves used can be controlled electrically or in another manner to direct the hydraulic flow. Flow directing valves 32,34 are preferably electrically controlled, and are operated to cause the hydraulic fluid 16 to flow from the motor outlet portion 26 to the pressure vessel 10,12 other than the one from which the hydraulic fluid 16 was expelled in the current stage of operation. In the positions shown in FIG. 1, valve 34 is open to allow the hydraulic fluid 16 to flow into pressure vessel 12, while valve 22 is closed, to prevent flow through the vessel inflow portion 20 that is associated with pressure vessel 10. In an alternative embodiment, the valves 32,34 can be replaced with other types of suitable valves, such as one-way valves, including check valves configured to direct the flow along the desired path.

A hydraulic accumulator 36 can be hydraulically connected to the conduit 14 to even the pressure and flow rate and smoothing variations and spikes of the hydraulic fluid flow through the motor 24. Preferably, the accumulator 36 is connected to the conduit 14 downstream of flow directing valves 30 and upstream of the motor 24. A suitable location is between the vessel outflow portions 18.

The accumulator 36 preferably includes a spring 38 to maintain a substantially consistent or constant pressure. The spring 38 can be a gas spring, such as an air spring, and in the preferred embodiment comprises compressed air at a pressure of around 175 psi. Other suitable accumulator systems can alternatively be used.

An expandable member is preferably operably associated with the hydraulic fluid 16 in one or both the pressure vessels 10,12. The expandable member preferably comprises a reversibly expandable fluid 40 contained within one or both of the pressure vessels 10,12 in hydraulic association with the hydraulic fluid 16. When the temperature of the expandable fluid 40 is changed, the expandable fluid expands or contracts sufficiently and at a sufficient rate to displace the hydraulic fluid 16 out from one of the pressure vessels 10,12 to the other 12,10. Thus, one of the pressure vessels 10,12 is provided with a higher pressure than the other 12,10, to bias the hydraulic fluid 16 between the pressure vessels 10,12 and through the motor 24 to generate power.

A heat exchanging assembly is in heat transferring association with the pressure vessels 10,12, and preferably with the expandable fluid 40 therein. The heat exchanging assembly preferably comprises a heat exchanger, such as a heat exchanger coil 42,44 associated with, and preferably extending within, one or both pressure vessels 10,12. Consequently, in the preferred embodiment, the expandable fluid is in thermal association with the heat exchanger coils 42,44, such that the heat exchanger coils 42,44 can alternately cause the expandable fluid 40 to expand and contract by alternating the temperature of the expandable fluid 40. In this manner, the internal pressures within the pressure vessels 10,12 are also varied. The expandable fluid 40 of the preferred embodiment is configured to expand when heated and to contract when cooled.

Although electric or other types of heat exchanging assemblies can be used, the preferred heat exchanger coils 42,44 are connected to hot and cold sources 50,52 of a thermal conducting fluid 45 via thermal conduits 46,48, such as water. The hot water source 50 can be heated in manners known in the art, but preferably employs a heat source that is readily available at the site at which the power plant is to be employed. The hot water source 50 can be heated for example by sunlight, a furnace, or an outlet of hot water from a factory, for example. If a source of hot water is already available, the hot water itself can be used. The cold water source 52 can also be cooled in a manner as known in the art, such as by a refrigeration system, but a readily available source of cold or cold water itself is preferably employed, such as water from a local river or stream. If the requisite difference in temperature can be obtained by simple heating the hot water source without cooling the cold water source, or vice versa, such arrangements can also be useable.

The thermal conduit 46 delivers the hot conducting fluid 45 to hot water valves 54,56, and the thermal conduit 48 delivers the cold conducting fluid 45 to cold water valves 58,60. Valves 54,58 are connected to heat exchanger coil 42 of pressure vessel 10, and valves 56,60 are connected to heat exchanger coil 44, to heat or cool the expandable fluid 40 with in the respective pressure vessels 10,12.

A controlling mechanism is preferably operably associated with the heat exchanging assembly, and preferably the hot and cold water valves 54,56,58,60 for controlling the operation thereof. The controller of the embodiment shown is configured to open hot water valve 54 and cold water valve 60 while closing cold water valve 58 and hot water valve 60 in a first stage of operation. Thus, hot water is delivered through heat exchanger coil 42 to heat and expand the expandable fluid 40 in the pressure vessel 10, and cold water is delivered through heat exchanger coil 44 to cool and contract the expandable fluid 40 in pressure vessel 12. In a second stage of operation, the controller preferably closes hot water valve 54 and cold water valve 60 and opens cold water valve 58 and hot water valve 60. This causes cold water to be delivered through heat exchanger coil 42 to cool and contract the expandable fluid 40 in the pressure vessel 10, and hot water is delivered through heat exchanger coil 44 to heat and expand the expandable fluid 40 in pressure vessel 12.

Pumps 62 can be provided for pumping the hot and/or cold water through the heat exchanging assembly. Pumps 62 in the embodiment shown are provided on the outlet side of the heat exchanger coils 42,44, but in an alternative embodiment, the pumps can be provided on the input side to the temperature controlling valves 54,56,58,60.

Shutoff valves 64 are provided to shut off the flow of the hot and/or cold water when desired. These shutoff valves 64 can be solenoid operated valves that are controlled by the controller or electrically by a separate switch.

In operation, the controller operates the temperature controlling valves 54,56,58,60 in the first stage of operation to heat the heat exchanger coil 42 to heat the expandable fluid 40 in pressure vessel 10 and to cool heat exchanger coil 44 and expandable fluid 40 in pressure vessel 12. These temperature controlling valves 54,56,58,60 are preferably operated substantially simultaneously. The expanding expandable fluid 40 in pressure vessel 10 increases the pressure therein and forces out hydraulic fluid 16 therefrom, which flows through the conduit 14 towards pressure vessel 12, in which the expandable fluid 40 is contracted and in which the internal pressure has decreased. Check valves 30 direct the hydraulic fluid 16 from pressure vessel 10 through the motor 24, which produces and outputs power, preferably electric power, which can be used, or stored, for example, in a battery. The controller causes valve 32 to close and valve 34 to open, thus providing the path for the hydraulic fluid 16 to flow into pressure vessel 12. FIG. 1 shows pressure vessel 10 full of hydraulic fluid 16 with the expandable member 40 contracted, at the beginning of the first stage. The level of hydraulic fluid 16 in pressure vessel 12 is considerably lower than in pressure vessel 10, and there is a sufficient amount of space available therein to be refilled with hydraulic fluid 16 after the first stage is complete.

When the level of hydraulic fluid 16 in pressure vessel 10 reaches a predetermined low point, and pressure vessel 12 is full of hydraulic fluid at the end of the first stage, the controller causes the second stage of operation to begin. In the second stage, the controller operates the temperature controlling valves 54,56,58, to heat the heat exchanger coil 44 to heat the expandable fluid 40 in pressure vessel 12 and to cool heat exchanger coil 42 and expandable fluid 40 in pressure vessel 10. These temperature controlling valves 54,56,58,60 again are preferably operated substantially simultaneously. The expanding expandable fluid 40 in pressure vessel 12 increases the pressure therein and forces out hydraulic fluid 16 therefrom, which returns through the conduit 14 towards pressure vessel 10, in which the expandable fluid 40 is contracted and in which the internal pressure has decreased. Check valves 30 direct the hydraulic fluid 16 from pressure vessel 12 through the motor 24, which continues to produce and output power. The controller causes valve 34 to close and valve 32 to open, thus providing the return path for the hydraulic fluid 16 to flow into pressure vessel 10. At the end of the second stage of operation, pressure vessel 10 is again full of hydraulic fluid 16 with the expandable member 40 contracted, and the level of hydraulic fluid 16 in pressure vessel 12 is again ready to receive hydraulic fluid from pressure vessel 10 when the controller switches the operation once again to the first stage. During this repeating cycle, in which the hydraulic fluid 16 flows alternately between the pressure vessels 10,12, the accumulator 38 smoothes power pulses by filling as pressure increases in the conduit 14, and emptying when the pressure decreases.

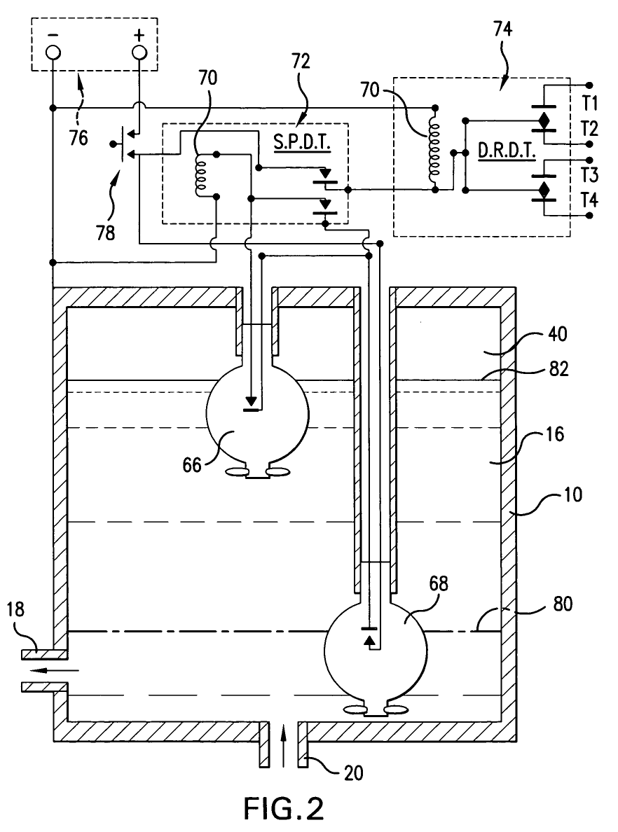

A vessel level sensor is preferably in sensing association with at least one of the pressure vessels 10,12 for sensing the level of hydraulic fluid 16 therein, sending a signal to the controller to switch from between the first and second stages of operation. A preferred vessel level sensor is shown in FIG. 2 and includes high and low level sensors 66,68. The level sensors include electrical switches that can be operated by floats or in another manner to be sensitive to the hydraulic fluid level. In the embodiment shown, the switches in the level sensors open and close to control relays 70 in a single pole double throw circuit 72 and in a double pole double through circuit 74. Electrical power is preferably provided to the controller circuitry by power source 76, which preferably comprises a battery charged by the motor 24. An on/off switch 78 is provided to cut power from the system to stop the power plant operation.

Referring to FIGS. 1 and 2, the controller operates such that terminals T1 and T3 are powered during the first stage of operation to open hot water valve 54, cold water valve 60, and valve 32 with valves 34,56,58 closed. The double pole double throw circuit 74 is then caused to remove power from terminals T1 and T3 and to power terminals T2 and T4 when the level of hydraulic fluid 16 reaches a predetermined low level 80 by operation of the low level sensor 68 to initiate the second stage of operation. Terminals T2 and T4 open cold water valve 58, hot water valve 56, and valve 34, and valves 32,54,60 closed. When the hydraulic fluid level reaches a predetermined high level 82, the controller returns the first stage of operation, powering terminals T1 and T3.

An alternative controller employs a microprocessor and other types of level sensors to signal the controller to change between the stages of operation. Additionally, whereas in the preferred embodiment the level sensors are only provided in one pressure vessel 10, they can alternatively be provided in both pressure vessels, with circuitry modified correspondingly.

In the preferred cycle, the expandable fluid 40 is substantially maintained within the power plant, and most preferably within the pressure vessels. The preferred cycle is thus closed with respect to the flow of the hydraulic fluid 16 and expandable fluid 40. The expandable fluid 40 preferably comprises a fluorocarbon or other refrigerant. Also, the preferred expandable fluid 40 comprises a gas, and in some embodiments can change between a liquid and gaseous state during repeating cycles of its expansion and compression.

Although the invention is illustrated with the use of an expandable fluid, any type of expandable member can be used. For example, a solid such as ice can expand as it warms to provide a pressure. Generally, any fluid (i.e., gas or liquid) that expands or contracts with heating or cooling can be used. It is also desirable that the expandable member generate relatively high pressures at a relatively low temperatures. Advantageously, the expandable fluid comprises a fluorocarbon or fluorocarbon mixture that (a) generates a high pressure of at least 100 to 400 psi or more at a pressure generation temperature that is below the boiling point of water, (b) has a boiling point which is below the freezing point of water, and (c) has a critical temperature which is above that of the pressure generation temperature. Preferably, the expandable fluid comprises a fluorocarbon mixture that (a) generates a high pressure of at least 500 psi at a pressure generation temperature that is below 190° F., (b) has a boiling point which is at least 10 degrees F. below the freezing point of water, and (c) has a critical temperature which is above 150° F.

Any one of a wide variety of expandable fluids can be utilized in this invention. Advantageously, these fluids generate relatively high pressures at temperatures that are well below the boiling point of water, and generally below 190° F. for the specific fluids disclosed herein. These fluids also have boiling temperatures that are significantly below the freezing point of water. Pressures of at least about 100 to as high as about 500 to 700 psi can be provided at a temperature in the range of about 120 to 180° F., with the most preferred fluids having pressure generating temperatures of between about 140 and 160° F. These high pressures are advantageous for efficiently operating turbines or related equipment for generating power or torque.

The most advantageous fluids are fluorocarbons, and while a single fluorocarbon may be used alone, it is preferred to instead use various mixtures and most preferably to utilize azeotropic mixtures. Suitable fluorocarbons for use as mediums include difluoropentafluoroethane, trifluoromethane, pentafluoroethane, tetrafluoroethane, and trifluoroethane. Certain mixtures may contain small amounts of other gases such as hydrocarbons or halogenated hydrocarbons provided that the overall properties of the mixture meet the above-stated property requirements.

The most preferred fluorocarbons and fluorocarbon mixtures include HFC-125, Blends 404A, 407C, and HP-80, Azeotrope 502, and Azeotropic mixtures AZ-20 and AZ-50, all of which are available from Allied Signal Chemicals, Morristown, N.J. AZ-20 is disclosed in U.S. Pat. No. 4,978,467, while AZ-50 is disclosed in U.S. Pat. No. 5,211,867. Other useful fluorocarbon mixtures are disclosed in U.S. Pat. No. 5,403,504. Each of these three patents is expressly incorporated herein by reference to the extent needed to understand these compounds.

The most preferred expandable fluid 40 is AZ 20, with which relatively small temperature differences between the hot and cold states of the heat exchange coils 42,44 and expandable fluid 40 can produce large changes in pressure and volume of the fluid 40. The maximum difference in temperature of the expandable fluid 40 is preferably less than about 100° F., and more preferably less than about 75° F. One embodiment using AZ 20 uses about a 50° F. maximum difference between the heated and the cooled expandable fluid 40 in the pressure vessels 10,12, with the heated expandable fluid 40 being at about 90° F. to about 130° F., for example at about 100° F., and the cooled expandable fluid 40 being at around 35° F. to about 80° F., for example about 50° F. A preferred minimum temperature difference is about 10° F., and more preferably about 20° F. The expandable fluid 40 in both pressure vessels 10,12 are preferably heated and cooled between approximately the same temperatures and pressures.

A preferred pressure difference between the heated and cooled expandable fluid 40 in the pressure vessels 10,12 driving the hydraulic fluid 40 through the motor is less than about 500 psi, and more preferably less than about 350 psi, and preferably more than about 50 psi. In a preferred embodiment, one pressure vessel is pressurized up to about 320 psi, while the other has a pressure of down to about 140 psi. The temperatures and pressures can be selected based on desired power output, materials used, and resources available.

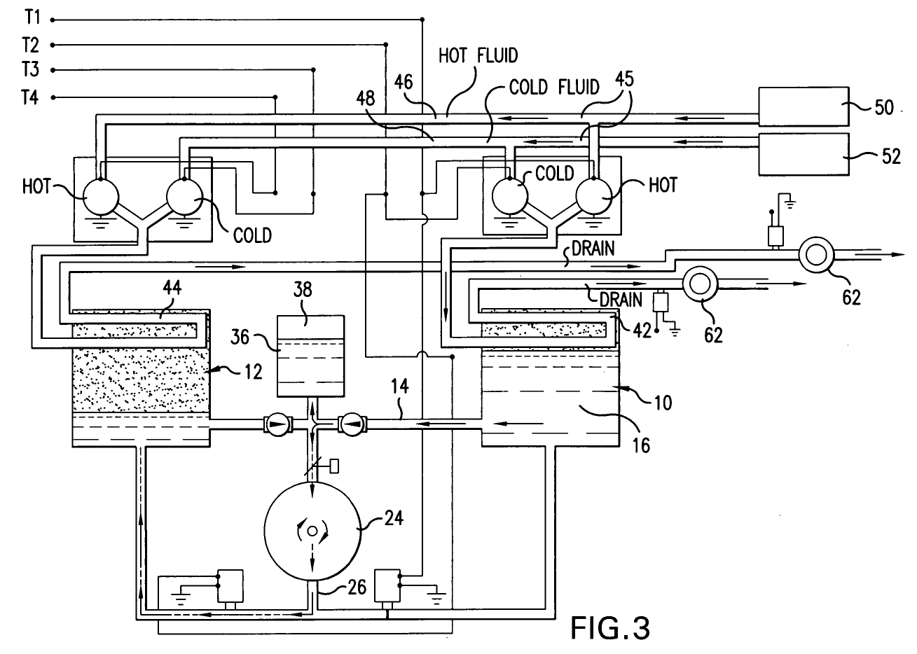

In another embodiment, shown in FIG. 3, the heating and cooling thermal conducting fluid 45, such as the hot and cold water in thermal conduits 46,48, is expelled from the system in an open flow circuit. This can be beneficial when water can easily be emptied into a nearby area, and a hot and cold water source are naturally or otherwise already available to operate the power plant.

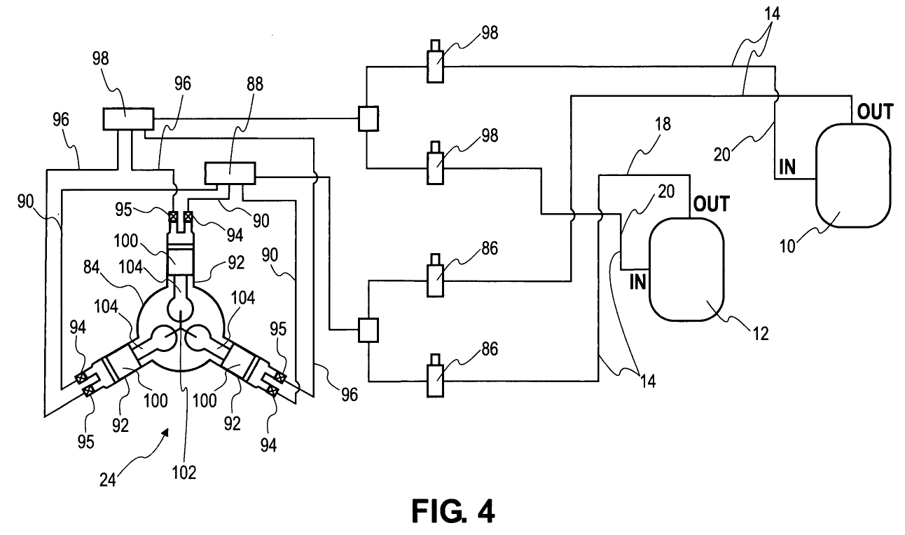

Referring to FIG. 4, an embodiment of the motor 24 is a piston motor 84 with one or more cylinders. The piston motor 84 that is shown has three cylinders 92 in a radial arrangement, although other arrangements and number of cylinders can be used, such as in-line, V, or horizontally opposed.

Valves 86 are operated by the controller to alternately direct the hydraulic fluid through the outflow portions 18 of the conduits 14 to an intake manifold 88, which distributes the hydraulic fluid through intake conduits 90 that lead to each cylinder 92. Exhaust conduits 96 deliver hydraulic fluid that exits the cylinders 92 to an exhaust manifold, which is connected with the inflow portions 20 of conduit 14. Valves 98 are operated in association with valves 68 by the controller to direct the hydraulic fluid to the appropriate pressure vessel 10,12, depending on the present stage of operation.

Pistons 100 are disposed within the cylinders 92 and are connected to a crank shaft 102 by piston rods 104, with the crank shaft 102 preferably connected to a generator or other power mechanism. Intake and exhaust valves 94,95 are preferably operated depending on the position of each piston 100 within the cylinders to deliver and exhaust the hydraulic fluid 16 from the cylinders 92. The valves 94,95 can be operated mechanically, electrically, electronically, or by other suitable methods known in the art.

During operation of each cylinder 92, the intake valve 94 opens to admit hydraulic fluid from the high pressure intake manifold 88 in to the cylinder 92 to drive the piston 100 down and rotate the crank shaft 102 during a power stroke. In an exhaust stroke, the piston 100 rises, preferably driven by the crankshaft 102, to expel the hydraulic fluid 16 from the cylinder 92 to the low pressure exhaust manifold 98.

A preferred embodiment employs at least three cylinders 92 so that no initial motion needs to be imparted on the motor 94 to start it moving in the desired direction. In the arrangement shown, for example, with the cylinders 92 placed equidistantly around the crankshaft 102, the pistons are preferably about 60° out of phase, so at least one is in the power stroke, which will cause the initial turning of the shaft 102 to be in the desired rotational direction.

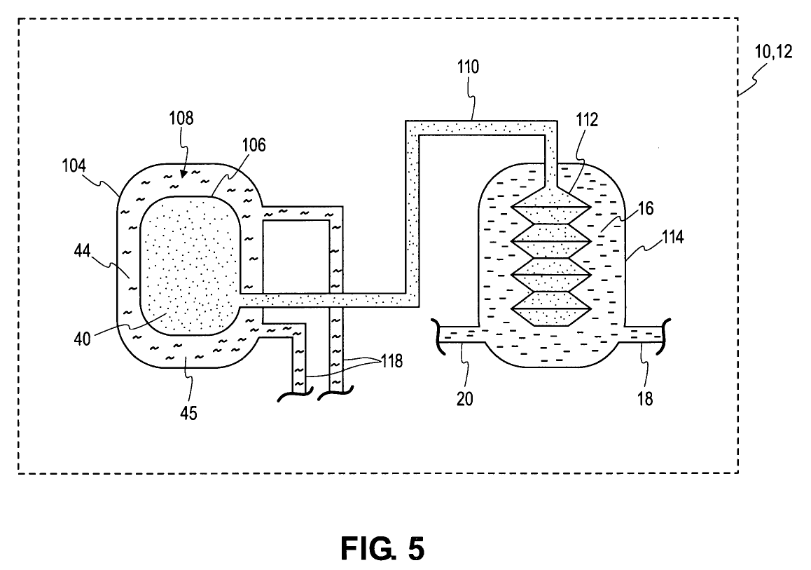

Another embodiment of a pressure vessel 10 or 12 is shown in FIG. 5, which is compartmentalized into a plurality of subvessels. A first subvessel 104 surrounds an expandable fluid chamber 106 that contains the expandable fluid 40, and which is preferably substantially rigid to hold its shape during the cycles of operation. Hot and cold heat conducting fluid 45 are alternately flowed through inlet and drain tubes 118 and through a jacket region 108 surrounding the expandable fluid chamber 106 to alter the temperature of the expandable fluid 40 in chamber 106. A conduit 110 allows the expandable fluid 40 to reciprocate between chamber 106 and an expandable chamber 112, for example formed as a bellows. A hydraulic fluid subvessel 114 contains the hydraulic fluid 16 and s preferably substantially rigid to hold its shape through the pressure cycles of the hydraulic 16 fluid therein. The volume of the expandable chamber 112 changes cyclically in response to the temperature change of the expandable fluid 40, thus pumping the hydraulic fluid 16 out of, and allowing the hydraulic fluid 16 back into, subvessel 116 during the operation.

While illustrative embodiments of the invention are disclosed herein, it will be appreciated that numerous modifications and other embodiments may be devised by those skilled in the art. For instance, the hydraulic fluid can be any suitable fluid, including water, and is preferably substantially incompressible. Alternatively, the hydraulic fluid can be compressible, and can be a gas, such as air, and in one embodiment is substantially the same fluid as the expandable member. Also, the heat exchanging mechanism can include a separate heater, such as an electrical resistance heater, which may be directly associated with the pressure vessels. Therefore, it will be understood that the appended claims are intended to cover all such modifications and embodiments that come within the spirit and scope of the present invention.

What is claimed is:

1. A power plant, comprising:
at least two pressure vessels containing a hydraulic fluid;
a heat exchanging assembly in heat transferring association with the pressure vessels;
a hydraulic conduit hydraulically connecting the pressure vessels;
a power output device in hydraulic association with the conduit between the vessels and configured for outputting power from the hydraulic flow of the hydraulic fluid flowing through the conduit; and
a controlling mechanism operably associated with the heat exchanging assembly for causing the heat exchanging assembly to alternately produce increased pressure in one of the pressure vessels compared to other such that the hydraulic fluid flows through the power output device alternately between the pressure vessels to produce the power.

2. The power plant of claim 1, further comprising an expandable member in thermal association with the heat exchanging assembly for expanding and contracting in response to alternating heat exchange with the heat exchanging assembly, the expandable member being operably associated with the hydraulic fluid in the pressure vessels for biasing the hydraulic fluid alternately between the pressure vessels through the conduit.

3. The power plant of claim 2, wherein the expandable member comprises an expandable fluid disposed within at least one of the pressure vessels in hydraulic association with the hydraulic fluid.

4. The power plant of claim 3, wherein the expandable fluid is substantially maintained within the power plant during cycles of the hydraulic fluid flow.

5. The power plant of claim 3, wherein the expandable fluid comprises a fluorocarbon.

6. The power plant of claim 3, wherein the expandable fluid comprises a gas.

7. The power plant of claim 3, wherein the expandable fluid changes between liquid and gaseous state during repeating cycles of expansion and compression.

8. The power plant of claim 3, wherein:
the heat exchanging assembly is connected to hot and cold sources of a thermal conducting fluid; and
the controlling mechanism comprises at least one temperature controlling valve to direct the thermal conducting fluid alternately from the:
hot source to heat the expandable fluid, and
cold source to cool the expandable fluid.

9. The power plant of claim 8, wherein the controlling mechanism comprises:
a controller operably associated with the temperature controlling valve; and
a vessel sensor in configured for sensing a level of hydraulic fluid in at least one of the pressure vessels, the controller being connected to the vessel sensor and configured for operating the temperature controlling valve depending on the level sensed by the vessel sensor.

10. The power plant of claim 9, wherein the vessel sensor is associated with only one of the pressure vessels for sensing the hydraulic fluid level therein.

11. The power plant of claim 9, wherein the controlling mechanism comprises electric circuitry associated with the vessel sensor for responding to the sensed hydraulic fluid level and controllingly associated with the controlling valve.

12. The power plant of claim 2, wherein the expandable member is configured to expand when heated and to contract when cooled.

13. The power plant of claim 1, wherein the conduit comprises:
outflow and inflow portions hydraulically connected between the pressure vessels and the power output device; and
flow directing valves associated with the outflow and inflow portions for directing the hydraulic fluid to flow from the pressure vessels to the power output device only through the outflow portions, and from the power output device to the pressure vessels only through the inflow portions.

14. The power plant of claim 13, wherein the flow directing valves comprise one-way flow valves.

15. The power plant of claim 13, further comprising an accumulator hydraulically connected to the conduit at an accumulator location between the output portions leading from the vessels for substantially smoothing pressure and flow rate changes of the hydraulic fluid flowing to the power output device.

16. The power plant of claim 13, wherein the conduit is configured for flowing the hydraulic fluid in a closed figure eight circuit, passing twice through the power output device before returning to either pressure vessel.

17. The power plant of claim 16, wherein the conduit is configured such that the hydraulic fluid in the closed circuit is directed sequentially from a first of the pressure vessels, trough a first of the outflow portions, through the power output device, through a second of the inflow portions, to a second of the pressure vessels, through a second of the outflow portions, through the power output device, through a first of the inflow portions, and back to the first pressure vessel.

18. The power plant of claim 1, further comprising an accumulator hydraulically associated with the conduit for substantially maintaining pressure and flow rate of the hydraulic fluid through the power output device.

19. The power plant of claim 1, wherein the power output device comprises a transducer for converting hydraulic power from the hydraulic fluid flow.

20. The power plant of claim 19, wherein the power output device comprises a hydraulic motor.

21. The power plant of claim 19, wherein the hydraulic motor comprises a piston motor comprising at least one cylinder set comprising a cylinder, a piston within the cylinder, and a crank shaft driven by the piston to output the power.

22. The power plant of claim 20, further comprising:
an intake manifold connected to deliver the hydraulic fluid from the hydraulic conduit to the cylinder to drive the piston;
an exhaust manifold connected to exhaust the hydraulic fluid from the cylinder to the hydraulic conduit.

23. The power plant of claim 22, wherein the motor comprises at least three cylinder sets.

24. A method of producing power in a power plant, comprising:
alternately and sequentially heating and cooling at least first and second pressure vessels such that one of the vessels is heated while the other is cooled to alternately increase a pressure in one of the vessels with respect to the other for displacing a hydraulic fluid reciprocally between the vessels through a hydraulic conduit; and
flowing the displaced hydraulic fluid in the conduit through a power output device to cause the output device to output power.

25. The method of claim 24, wherein the pressure in the vessels is varied by alternately heating and cooling an expandable gas within the pressure vessels.

26. The method of claim 25, wherein the gas is substantially maintained in the power plant throughout the alternating increase and decrease of the pressures.

27. The method of claim 24, further comprising operating flow directing valves associated for directing the hydraulic fluid in a single direction through the power output device from the first to the second pressure vessel and from the second to the first pressure vessel.
